(19) United States
(12) Patent Application Publication
(10) Pub. No.: US 2002/0065114 A1
(43) Pub. Date: May 30, 2002

(54) Composite pen coupled with an earphone

(76) Inventor: Wen-Jung Lin, Taipei (TW)

Correspondence Address: BACON & THOMAS, 4th Floor, 625 Slaters Lane, Alexandria, VA, 22314, US

(21) Appl. No.: 09/778,092

(22) Filed: Feb. 7, 2001

(30) Foreign Application Priority Data
Nov. 24, 2000 (TW) 89220369

(51) Int. Cl. H04B 1/38

(52) U.S. Cl. 455/568; 455/90; 455/569

(57) ABSTRACT

A composite pen coupled with an earphone for a mobile phone (4) includes a pen (1) and a chamber (2) located at one end of the pen that has a circuit board (3) disposed therein. The Circuit board (3) connects to an output unit (34), an input unit (35) and a connector (36). The connector (36) may plug in the mobile phone (4) for the output unit (34) to broadcast the audio sound from the mobile phone (4) and the input unit (35) to receive verbal voice from the user. The composite pen thus has both writing and earphone capability.

### BACKGROUND OF THE INVENTION

This invention relates to a composite pen coupled with an earphone and particularly a composite pen that equips both writing and earphone function.

The rapid innovation in information and telecommunication technology has caused growth explosion of mobile phone in recent years. A lot of mobile phone peripheral devices have also been developed and introduced to meet the needs and desires of the vast mobile phone population. Among them, earphone is one of the most sought after items. Because the phone may come in any moment when people are working or engaging in other activities such as driving, a car or riding a motorcycle, to get the communication flow smoothing without the hand occupied becomes an important issue Aid by the earphone, user's hands and mind may be freed to do other things with more concentration This is especially true during driving a car. And it could prevent a lot of accident from happening.

Most earphones now available on the market include an earpiece attached to a microphone. When coupled to a mobile phone, it can only be used as a simple earphone. In the event users want to write something during conversation, users have to fumble for a pen. It could distract users and cause trouble or waste extra line charge time, especially during driving a car. There is a need for a more convenient and safer way to use the earphone.

### SUMMARY OF THE INVENTION

In view of the foregoing disadvantages, it is therefore an object of this invention to provide a composite pen which is coupled with an earphone so that user may use the earphone and pen conveniently without distraction.

The composite pen according to this invention includes a pen (1) and a chamber (2) located at one end of the pen that has a circuit board (3) disposed therein. The circuit board (3) connects to an output unit (34), an input unit (35) and a connector (36). The connector (36) may plug in a mobile phone (4) for the output unit (34) to broadcast the audio sound from the mobile phone (4) and the input unit (35) to receive verbal voice from the user to complete the earphone function.

### BRIEF DESCRIPTION OF THE DRAWINGS

The invention, as well as its many advantages, may be further understood by the following detailed description and drawings.

FIG. 1 is a perspective of this invention.

FIG. 2 is an exploded of this invention.

FIG. 3 is a sectional view of this invention.

FIG. 4 is a pictorial view of this invention in use.

FIG. 5 is a block diagram of audio process flow of this invention

### DESCRIPTION OF THE PREFERRED EMBODIMENT

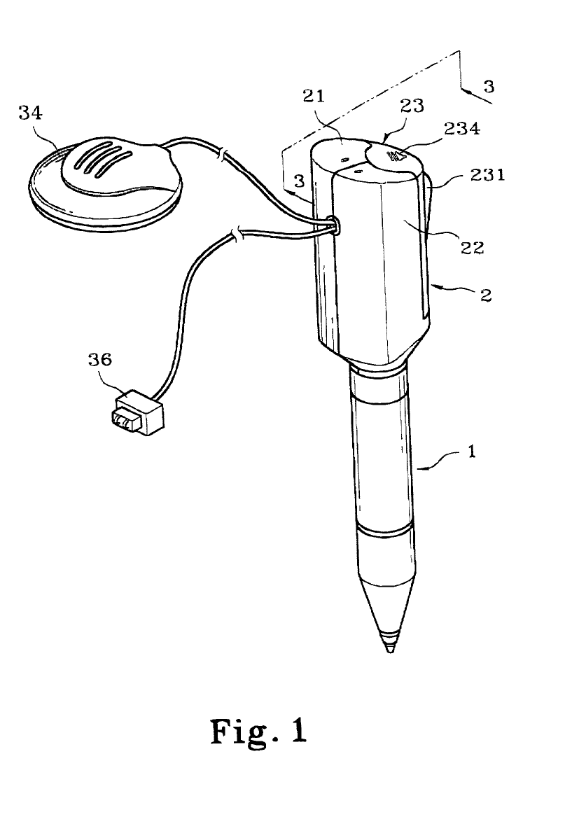

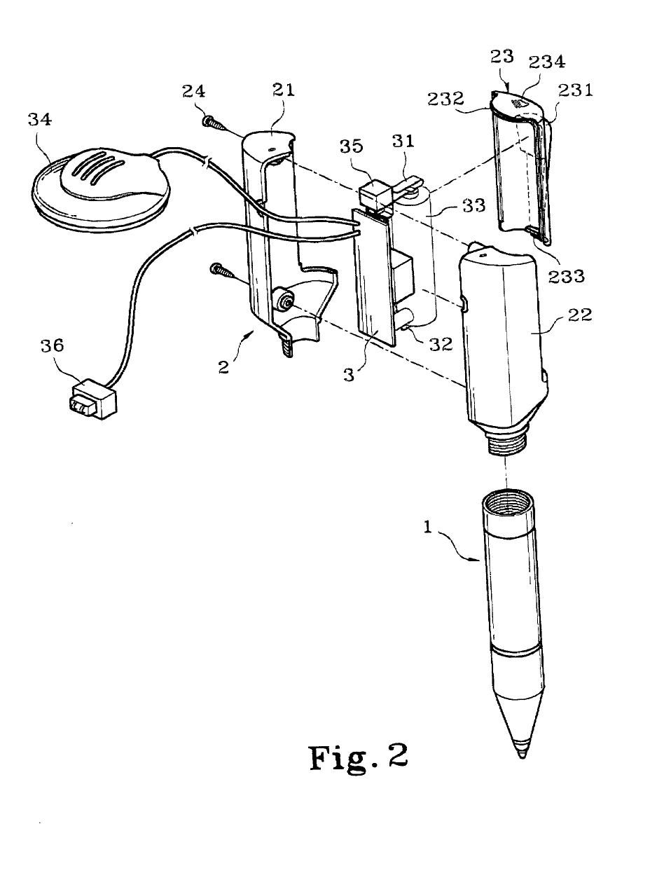

Referring to FIGS. 1 and 2, the composite pen 1 according to this invention is coupled with an earphone function for a mobile phone. The pen 1 includes a chamber 2 located at on end of the pen 1. The chamber 2 has a first shell 21, a second shell 22 and a cap 23 fastened together by means of fasteners 24. The cap 23 has a clip 231 for engaging with user's clothing to hold the pen securely on user's dress, The cap 23 further has a first snap element 232 located at one end and a second snap element 233 located at another end thereof. The cap 23 is engaged with the chamber 2 through the first and second snap element 232 and 233. The chamber 2 includes a circuit board 3 which has an elastic positive contact 31 and an elastic negative contact 32 for holding a battery 33 therebetween to supply electric power needed. The circuit board 3 further connects to an output unit 34, an input unit 35 and a connector 36. The output unit 34 may be a speaker, the input unit may be a microphone, and the connector 36 may be a plug compatible to and engageable with a mobile phone desired. Once the connector 36 is plugged in the mobile phone, the output unit 34 may produce output sound and the input unit 35 may receive voice input from the user. Hence the pen 1 may equip both writing and earphone function.

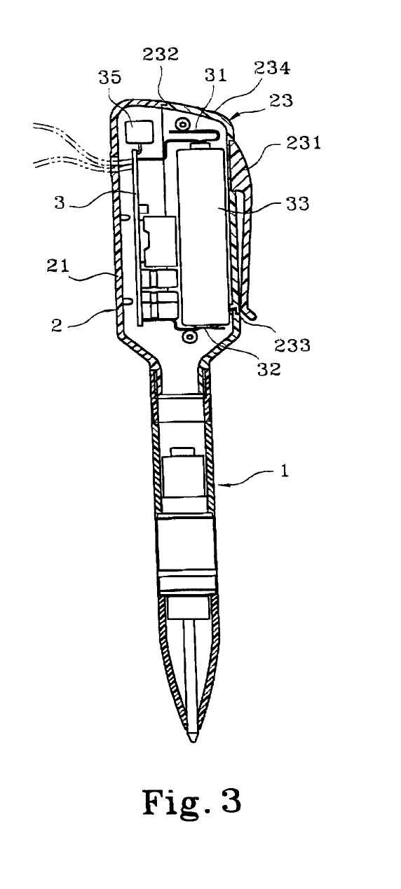

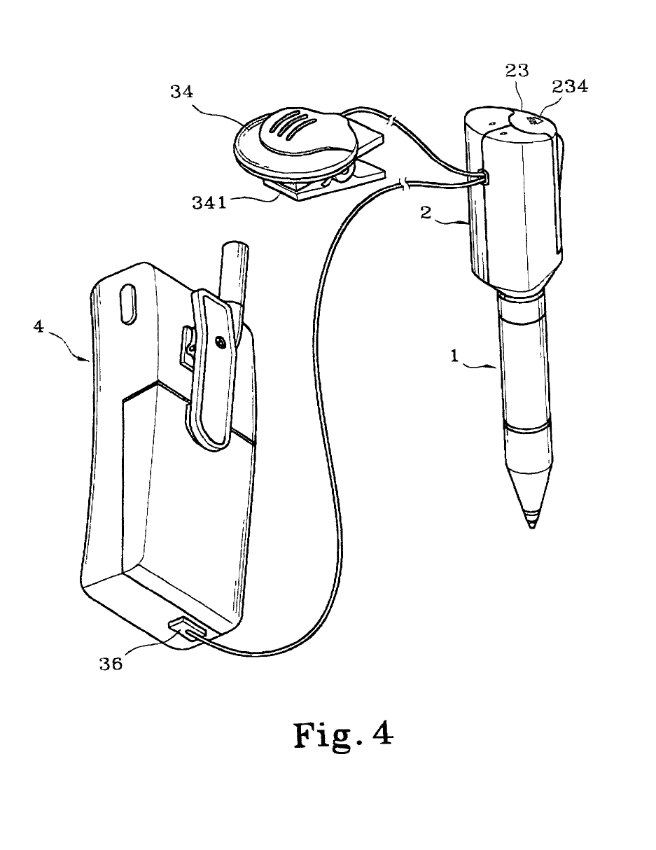

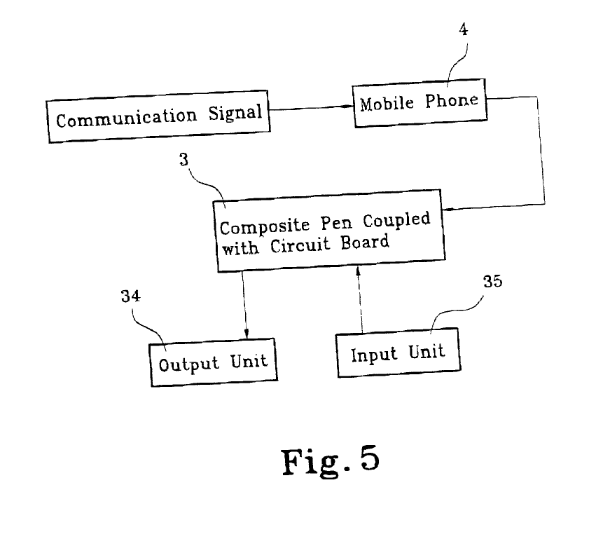

Referring to FIGS. 3, 4 and 5, the circuit board 3 is constructed like the one used in a conventional mobile phone and is known in the art, thus will be omitted herein. When in use, plug the connector 36 in a mobile phone 4, the output unit 34 has a clamp 341 which along the clip 231 may enable the pen 1 and output unit 34 be fastened to locations desired to suit user's preference. When the mobile phone 4 does not receive signal, it is at a standby state. Once the mobile phone 4 receives signals, it is activated and starts to generate audio sound through the output unit 34. User's speaking voice will be received through the input unit 35 which substitutes the function of the receiver of the mobile phone. When the user wants to write down something, the pen 1 may be used directly. When the power of the battery 33 runs out, the cap 23 may be opened by pushing a latch element 234 located at the top end of the cap 23 to disengage the first snap element 232 from one end of the chamber 2, then move the cap 23 upward to disengage the second snap element 233 from another end of the chamber 2 and remove the cap 23 from the chamber 2. Then the battery 33 will be exposed for replenishment

It may thus be seen that the objects of the present invention set forth herein, as well as those made apparent from the foregoing description, are efficiently attained. While the preferred embodiment of the invention has been set forth for purpose of disclosure, modifications of the disclosed embodiment of the invention as well as other embodiments thereof may occur to those skilled in the art.

What is claimed is:

1. A composite pen comprising a pen (1) coupled with an earphone for a mobile phone (4), wherein:
the pen (1) has a chamber (2) located at one end thereof, the chamber (2) including a circuit board (3) which has an output unit (34), an input unit (35) and a connector (36), the connector (36) being capable of plugging in the mobile phone (4) for the output unit (34) to output audio sound from the mobile phone (4) and the input unit (35) to receive verbal voice from the user such that the pen (1) having both writing and earphone capability.

2. The composite pen of claim 1, wherein the chamber (2) includes a first shell (21), a second shell (22) and a cap (23) fastened together by fasteners (24), the cap (23) having a clip (231) located at one side, a first snap element (232) located at one end and a second snap element (233) located at another end to engage with the chamber (2).

3. The composite pen of claim 1, wherein the circuit board (3) has an elastic positive contact (31) and an elastic negative contact (32) for holding a battery (33) therebetween for supplying electric power.

4. The composite pen of claim 1, wherein the output unit (34) is a speaker.

5. The composite pen of claim 1, wherein the output unit (34) has a clamp (341) for holding the output unit (34) at a location desired.

6. The composite pen of claim 1, wherein the input unit (35) is a microphone.

7. The composite pen of claim 1, wherein the connector (36) is a selected connector for connecting to the mobile phone (4).
